(19) United States
(12) Patent Application Publication
(10) Pub. No.: US 2014/0153738 A1
(43) Pub. Date: Jun. 5, 2014

(54) WIRELESS INDUCTION SYSTEM FOR PRODUCING AUDIO

(71) Applicants: Zhengmin Benjamin Pan, California, CA (US); Bingke Zhu, Shenzhen (CN)

(72) Inventors: Zhengmin Benjamin Pan, California, CA (US); Bingke Zhu, Shenzhen (CN)

(73) Assignees: AAC ACOUSTIC TECHNOLOGIES (SHENZHEN) CO., LTD., Shenzhen (CN); AAC MICROTECH(CHANGZHOU) CO., LTD., Changzhou (CN)

(21) Appl. No.: 14/093,764

(22) Filed: Dec. 2, 2013

(30) Foreign Application Priority Data
Dec. 3, 2012 (CN) 201220656627.9

(51) Int. Cl. H04R 3/00

(52) U.S. Cl. CPC H04R 3/00
USPC 381/79

(57) ABSTRACT

A wireless induction system includes a first device and a second device wirelessly connected the first device, the first device and the second device separated from each other. The first device is configured for generating electromagnetic signals and includes a signal source and a transmitting unit electrically connected with the signal source. The second device is configured for receiving electromagnetic signals and converting it into audio signals, and includes a receiving unit, a processor and a loudspeaker.

### RELATED PATENT APPLICATION

This application claims the priority benefit of Chinese Patent Application Filing Serial Number CN 201220656627.9, the disclosure of which is herein incorporated by reference in its entirety.

### FIELD OF THE INVENTION

The present disclosure relates to the art of electronic devices and, particularly to a wireless induction system for producing audio according to induced wireless electromagnetic signal.

### DESCRIPTION OF RELATED ART

With the rapid development of technologies, the design of electronic devices, such as computer, cellular phones, PDAs (personal digital assistants), and so on, is being driven by the marketplace towards providing more and more multimedia functions.

The foregoing electronic devices generally include an audio module. The audio module is typically accommodated within the electronic device. If or when the audio module becomes dysfunctional, the electronic device must be discarded or need to be disassembled to replace the audio module. This may be expensive. Typically, it is unavoidable that the electronic devices have a proper wire cable for transmitting or receiving electrical signals. In order to obtain or amplify loud sound generated or produced by the electronic device, the audio module is electrically connected with an exterior audio speaker via the cable. In some other instances, the audio module is positioned on a dock with a plurality of conductive points thereof electrically connected with the dock for transmitting the audio signals to the dock and playing sounds by the speakers built in the dock. However, it is inconvenient to use a long cable that may tangle together or to use a short cable that does not fit the actual need.

Therefore, it is desirable to provide an improved wireless induction system which can overcome the above-mentioned problems.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a configuration of a wireless induction system in accordance with a first embodiment of the present disclosure; and

FIG. 2 is a schematic view of a configuration of a wireless induction system in accordance with a second embodiment of the present disclosure.

### DETAILED DESCRIPTION OF THE EMBODIMENTS

Reference will now be made to describe the exemplary embodiments of the present disclosure in detail.

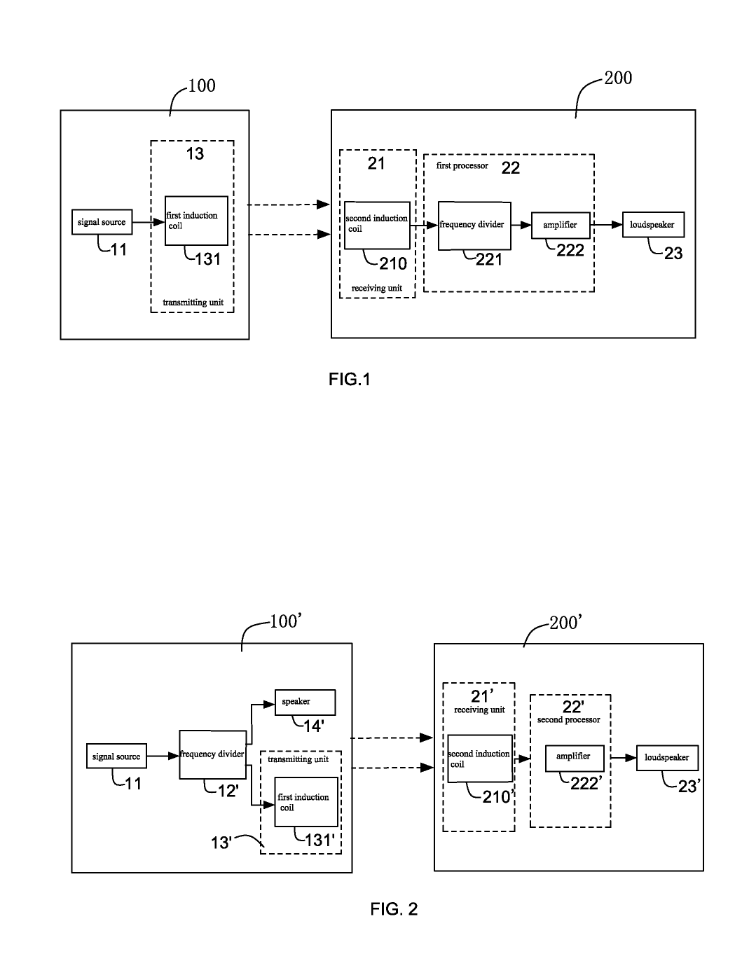

Referring to FIG. 1, which illustrates a first embodiment of the present invention, a wireless induction system of the present disclosure is disclosed. The wireless induction system includes a first device 100 having a transmitting unit 13 for generating a wireless electromagnetic signal, and at least one second device 200 responding to the first device 100 for receiving the wireless electromagnetic signal and converting it to sound. The first device 100 and the second device 200 are separated from each other, but are capable of communicating with each other wirelessly. The first device 100 further includes a signal source 11 for providing audible signals to the transmitting unit 13. The transmitting unit 13 convents audible signals into electromagnetic signals and emits the electromagnetic signals by a first induction coil 131. The first induction coil 131 may be, for example, a voice coil, a hearing coil or a near field communication antenna. The electromagnetic signal produces an electromagnetic field by a current flowing through the first induction coil 131. In addition, the first device 100 may be a portable electronic equipment, such as a phone or an MP3 player, etc.

The second device 200 is preferably placed within a reception range of the electromagnetic signal that will be receiving the electromagnetic signal.

Generally, the second device 200 includes a receiving unit 21 having a second induction coil 210, a first processor 22 and a loudspeaker 23. The second induction coil 210 is adapted to induce corresponding to the electromagnetic signal from the first device 100 and generate an audio signal. The first processor 22 is electrically connected between the receiving unit 21 and the loudspeaker 23, configured for processing the audio signal received and transmitted by the second induction coil 210. Optionally, the first processor 22 includes a frequency divider 221 and an amplifier 222 coupler to the frequency divider 221. The amplifier 222 is an electronic amplifier that amplifies low-power audio signals to a level suitable for driving the loudspeaker 23, which is a typical audio playback chain.

Referring to FIG. 2, which illustrates a second embodiment, a wireless induction system also includes a first device 100′ and a second device 200′ separated from the first device 100′, but communicating with the first device wirelessly. In other words, the first device 100′ and the second device 200′ are independent equipment. The first device 100′ has a signal source 11′, a frequency divider 12′ coupled to the signal source 11′, a speaker 14′ and a transmitting unit 13′. The frequency divider 12′ is electrically connected between the speaker 14′ and the transmitting unit 13′, and configured for processing audio signals provided by the signal source 11 and outputting them to the transmitting unit 13′. The transmitting unit 13′ has a first induction coil 131′ for generating an electromagnetic wave corresponding to the audio signal. The first device 100′ may be a portable electronic equipment, such as a phone or an MP3 player, etc.

The second device 200′ includes a receiving unit 21′ having a second induction coil 210′, a second processor 22′ and a loudspeaker 23′. In the embodiment, the second processor 22′ has an amplifier 222′. While the second device 200′ approaches to the first induction coil 131, the second induction coil 210′ detects and induces a current corresponding to the electromagnetic waves. The second processor 22′ processes the induced current and amplifies it for transmitting to the loudspeaker 23′.

In the present disclosure, when the speaker 14′ of the first device becomes dysfunctional, a user can easily provides one second device close to approach the first device within the reception range of the electromagnetic signal. An electromagnetic signal will be generated by the first induction coil of the first device. A current is induced in the second induction coil of the second device corresponding to the electromagnetic signal. The processor processes the induced current and converts it into audio signals. The audio signals are receiver by the loudspeaker of the second device as so to produce a sound. It is very convenient.

In each of the embodiments described above, a frequency divider is used, either used in the first device, or used in the second device. It is, however, an optional component to precisely transfer audible signals. In alternative instances, the first device may comprise a frequency divider for dividing the audible signals from the signal source into audio signal branches with different frequency ranges. Each of the audio signal branches is transmitted to the second device by a corresponding induction coil in the first device. Accordingly, the second device comprises a plurality of second induction coils for receiving corresponding audio signal branch, and for transmitting the audio signal branches to corresponding loudspeakers.

Alternatively, the frequency divider may be built in the second device. While the second induction coil in the second device receives the audible signals from the first device, the frequency divider in the second device divides the signals into audio signal branches with different frequency ranges. Apparently, the second device should comprise a plurality of loudspeakers corresponding to the different audio signal branches.

While the present invention has been described with reference to specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. A wireless induction system, comprising:
a first device configured for generating electromagnetic signals, including a signal source and a transmitting unit electrically connected with the signal source;
a second device configured for receiving electromagnetic signals and converting it into audio signals, and including a receiving unit, a processor and a loudspeaker;
the first device and the second device separated from each other, but communicated with each other by the electromagnetic signals.

2. The wireless induction system as claimed in claim 1, wherein the transmitting unit includes at least a first induction coil, the second device comprises a second induction coil corresponding to the first induction coil.

3. The wireless induction system as claimed in claim 2, wherein the processor includes a frequency divider electrically connected with the second induction coil and an amplifier electrically connected with the frequency divider.

4. The wireless induction system as claimed in claim 2, wherein the processor includes an amplifier configured for amplifying low-power audio signals to a level suitable for driving the loudspeaker.

5. The wireless induction system as claimed in claim 3, wherein the first device means a phone or an MP3 player.

6. The wireless induction system as claimed in claim 4, wherein the first device further includes a frequency divider electrically connected between the signal source and the transmitting unit.

7. The wireless induction system as claimed in claim 6, wherein the first device means a phone or an MP3 player.

8. A wireless audio system, comprising:
a first device including a signal source for providing audible signals, and a transmitting unit for receiving and transmitting the audible signals from the signal source;
a second device including a receiving unit for wirelessly receiving the audible signal by electromagnetic induction, a frequency divider receiving the audible signal from the receiving unit and dividing the audible signal into audio signal branches with different frequency ranges, and a plurality of loudspeakers corresponding to the audio signal branches.

9. The wireless audio system as described in claim 8, wherein the second device further comprises a plurality of amplifiers for correspondingly receiving the audio signal branches and transmitting the amplified signals to the corresponding loudspeakers.

10. The wireless audio system as described in claim 8, wherein, the transmitting unit and the receiving unit comprise induction coils.

11. A wireless audio system, comprising:
a first device including a signal source providing audible signals, a frequency divider receiving the audible signals and dividing the audible signals into audio signal branches with different frequency ranges, a plurality of transmitting units for respectively receiving and transmitting the audio signal branches from the corresponding frequency dividers;
a second device including a plurality of receiving units for wirelessly receiving the audio signal branches by electromagnetic induction, and a plurality of loudspeakers corresponding to the audio signal branches.

12. The wireless audio system as described in claim 11, wherein, the transmitting unit and the receiving unit comprise induction coils.
